(19) United States
(12) Patent Application Publication
(10) Pub. No.: US 2006/0179946 A1
(43) Pub. Date: Aug. 17, 2006

(54) Method and apparatus for washing a probe or the like using ultrasonic energy

(75) Inventor: Brian D. Wilson, Chaska, MN (US)

Correspondence Address: BECKMAN COULTER, INC., P.O. BOX 169015, MAIL CODE 32-A02, MIAMI, FL, 33116-9015, US

(73) Assignee: Beckman Coulter, Inc., Fullerton, CA (US)

(21) Appl. No.: 11/048,085

(22) Filed: Feb. 1, 2005

(51) Int. Cl. G01H 17/00

(52) U.S. Cl. 73/570

(57) ABSTRACT

An apparatus and corresponding method for ultrasonically washing a probe or the like are disclosed. The apparatus comprises an ultrasonic wave generator and an ultrasonic wave concentrator. The ultrasonic wave concentrator includes a body portion having a wash cavity. The wash cavity is shaped to generally conform to an exterior portion of the probe. A first end of the ultrasonic wave concentrator is adapted to receive ultrasonic energy produced by the ultrasonic wave generator. The ultrasonic energy received at the first end of the concentrator is focused into the wash cavity where it is used to wash the probe (or other object). A second end of the ultrasonic wave concentrator includes an aperture that is open to the wash cavity and is adapted to receive the probe and allow it to enter the wash cavity.

### FIELD OF THE INVENTION

The present invention is generally directed to methods and apparatus used to wash a probe or the like in a laboratory instrument. More particularly, the present invention includes methods and apparatus that employ ultrasonic energy to wash such a probe or the like.

### BACKGROUND OF THE INVENTION

In order to execute a desired preparation and/or analysis operation, laboratory instruments must frequently transfer a substance from one locus to another. Such transfers often include transporting predetermined volumes of liquid samples or reagents between sample containers, reagent containers, reaction cuvettes, and other receptacles. The particular tools used in these transfers include pipetters, sampling probes, etc. Often, these tools have elongated bodies with small cross-sections. Depending on the function of the tool, the elongated body may be hollow.

One problem associated with tools of this type is the carryover of residual traces of a previously dispensed sample or reagent to a container having another sample or reagent. Carryover, particularly of fluid reagents and samples, results in poor quality and repeatability of the preparation and/or analysis operation. Consequently, the transfer tool must be thoroughly cleaned between transfer steps.

Various methods and apparatus have been designed to wash such tools and thereby prevent carryover. One such apparatus is shown and described in U.S. Pat. No. 4,516,437, issued May 14, 1995, to Pedroso et al., and entitled “Microsample Handling Apparatus”. The apparatus disclosed in the '437 patent includes a probe for aspirating a sample and a cleaning mechanism having a passageway within which the probe is movable. The passageway has a cleaning chamber having opposite ends. One end is open to the atmosphere and proximate to the sample. The cleaning mechanism further includes a fluid director and two vacuum applicators. The vacuum applicators are disposed at opposite ends of the chamber while the fluid director is disposed between them. During a cleaning mode, the fluid director injects a wash fluid against the probe and the vacuum applicator removes the wash fluid, prevents exiting of the wash fluid and dries the probe. These latter to operations are accomplished by permitting gas from the atmosphere to flow into the cleaning chamber.

A further apparatus designed to prevent carryover is set forth in U.S. Pat. No. 4,991,451, issued Feb. 12, 1991, to Rodomista et al., and entitled “Probe Wiping”. The '451 patent is purportedly directed to an apparatus for removing fluid residue from an outer surface of a probe after it has been exposed to a fluid sample. The apparatus includes a wiper having a contact surface for wiping the residue from the outer surface of the probe. The apparatus also includes a fluid flow path that cooperates with the contact surface for withdrawing wiped residue away from the contact surface in the probe. A further mechanism is provided for causing the contact surface to be swept along the outer surface of the probe to cause relative motion between the two.

Further probe washing apparatus are likewise known in the art. Such apparatus include those disclosed in U.S. Pat. No. 4,730,631; U.S. Pat. No. 4,817,443; U.S. Pat. No. 5,186,194; U.S. Pat. No. 5,603,342; and U.S. Pat. No. 5,827,744.

Ultrasonic energy may be used to assist in the probe tip washing process. One such apparatus that employs ultrasonic energy in this manner is set forth in U.S. Pat. No. 5,846,491, issued on Dec. 8, 1998, to Choperena et al., and entitled “Device for Automatic Chemical Analysis”. The '491 patent generally references the attachment of an ultrasonic generator to the tip of a sampling probe. The ultrasonic energy is used to mix fluids, to level sense and to aid in cleansing of the probe. However, the '491 patent merely expresses this desired end and fails to disclose any structure for the combined probe tip/ultrasonic generator. A similar suggestion is included in U.S. Pat. No. 5,128,103, issued Jul. 7, 1992, to Wang et al., and entitled “Apparatus for Automatically Processing Magnetic Solid Phase Reagents”.

Although the art has suggested combining a probe tip with an ultrasonic generator in a general manner for, inter alia, cleansing purposes, a workable use of ultrasonic energy to clean a probe or the like has not yet been found.

### SUMMARY OF THE INVENTION

An apparatus and corresponding method for ultrasonically washing a probe or the like are disclosed. The apparatus comprises an ultrasonic wave generator and an ultrasonic wave concentrator. The ultrasonic wave concentrator includes a body portion having a wash cavity. The wash cavity is shaped to generally conform to an exterior portion of the probe. A first end of the ultrasonic wave concentrator is adapted to receive ultrasonic energy produced by the ultrasonic wave generator. The ultrasonic energy received at the first end of the concentrator is focused into the wash cavity where it is used to wash the probe (or other object). A second end of the ultrasonic wave concentrator includes an aperture that is open to the wash cavity and is dimensioned to receive the probe and allow it to enter the wash cavity.

A method for ultrasonically washing a probe or the like is also disclosed. In accordance with the method, ultrasonic wave energy is generated at a first energy density level. This ultrasonic wave energy is then concentrated to a second energy density level the that is focused into a wash cavity that is adapted to closely conform to an exterior portion of the probe (or the like). The second energy density level has a greater magnitude than the first energy density level. An amount of cleaning fluid is directed into the wash cavity and the probe is inserted for ultrasonic cleaning

### BRIEF DESCRIPTION OF THE DRAWINGS

FIG. 1 is a cross-sectional view of a probe cleaning apparatus constructed in accordance with one embodiment of the present invention.

FIGS. 2A-2C are cross-sectional views of various embodiments of ultrasonic energy concentrators suitable for use in the apparatus shown in FIG. 1.

FIG. 3 is a side view of a second embodiment of a probe cleaning apparatus.

FIGS. 4A and 4B are cross-sectional views of one embodiment of a fluid shower spray path employed in the embodiment shown in FIG. 3.

FIG. 5 is a cross-sectional view of one embodiment of a vacuum path employed in the embodiment shown in FIG. 3.

### DESCRIPTION OF PREFERRED EMBODIMENTS OF THE INVENTION

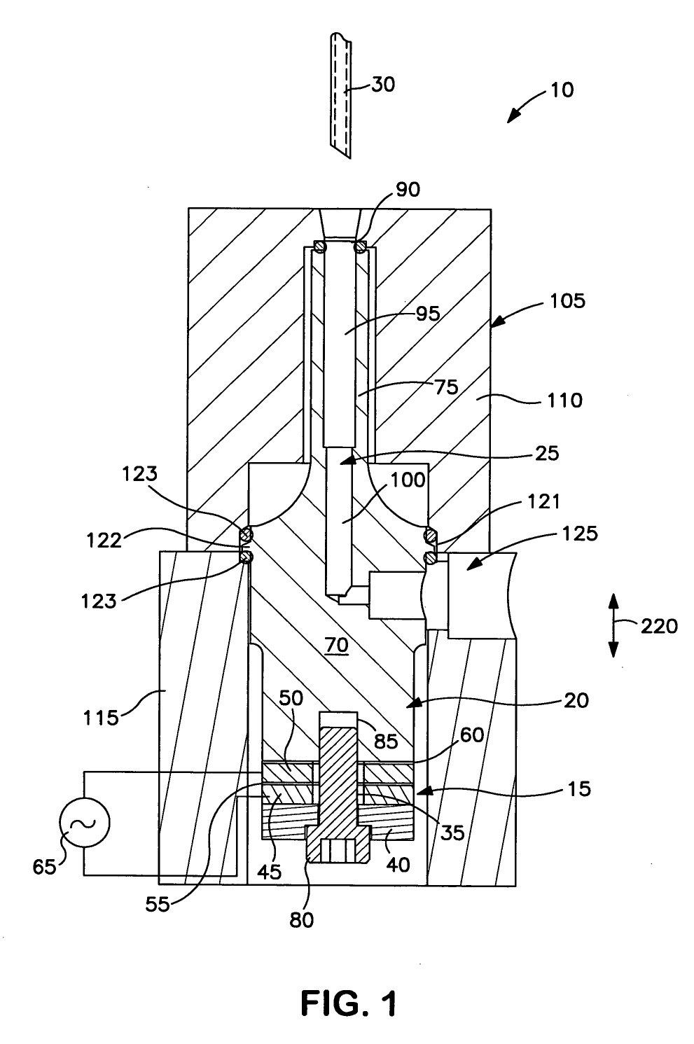

One embodiment of an apparatus suitable for cleaning a probe or the like using ultrasonic energy is shown at 10 of FIG. 1. Generally stated, the apparatus 10 includes an ultrasonic wave generator 15 and an ultrasonic wave concentrator 20 having a wash cavity 25 formed therein. Preferably, the ultrasonic wave generator 15 and ultrasonic wave concentrator 20 form a resonant, half-wave structure at the desired ultrasonic frequency of operation. Wash cavity 25 is dimensioned to closely conform to an exterior portion of a probe 30. For example, wash cavity 25 may have an interior diameter between 3.1 and 3.8 millimeters to accommodate a probe 30 having an exterior diameter between 1.6 and 1.9 millimeters. Clearances between the interior wall of the wash cavity 25 and the exterior of a typical probe 30 preferably range between 0.6 and 1.1 millimeters in basic embodiments, although other clearances may likewise be employed. Although probe 30 and wash cavity of the illustrated embodiment are cylindrical in shape, other shapes may likewise be used depending on design requirements.

The ultrasonic wave generator 15 is adapted to produce the ultrasonic wave energy that is utilized to clean probe 30. In the illustrated embodiment, generator 15 is formed as a cylindrical structure having a central aperture 35. The structure of the generator 15 is comprised of a plurality of individual components. The individual components of the illustrated embodiment include a head mass 40, first and second piezoelectric crystals 45 and 50 and a pair of disk-shaped electrodes 55 and 60. Piezoelectric crystals 45 and 50 are likewise disk-shaped and each one includes corresponding opposed planar surfaces. Electrode 60 includes a first surface proximate to the first end of wave concentrator 20 and a second surface in electrical contact with piezoelectric crystal 50. Electrode 55 includes a first surface in electrical contact with piezoelectric crystal 45 and a second surface in electrical contact with piezoelectric crystal 50. Piezoelectric crystal 45 is in contact with the headmass 40.

Piezoelectric crystals 45 and 50 are preferably formed from lead zirconate titanate and are used to generate the requisite ultrasonic vibrations in response to electrical signal simulation received through electrodes 55 and 60 from a source of electrical power 65. Electrodes 55 and 60 are preferably formed from beryllium-copper. Head mass 40 assists in reflecting and directing ultrasonic wave energy generated by piezoelectric crystals 45 and 50 toward the ultrasonic wave concentrator 20. Head mass 40 and wave concentrator 20 are preferably formed from stainless steel or titanium.

Ultrasonic wave concentrator 20 operates to focus the ultrasonic wave energy provided by the generator 15 into the wash cavity 25 and its contents. This may be accomplished by constructing the wave concentrator 20 so that it receives ultrasonic wave energy at a first energy density level from the generator 15 and concentrates this ultrasonic energy to a second, higher energy density level within wash cavity 25. Ultrasonic wave concentrator 20 can also be constructed from the viewpoint of antenna theory in which the concentrator 20 is constructed as an ultrasonic wave antenna that directs a narrow beam of ultrasonic wave energy toward a fluid within the wash cavity 25 from a broad beam ultrasonic wave signal received from wave generator 15.

In the illustrated embodiment, ultrasonic wave concentrator 20 is generally horn-shaped and includes a cylindrical body portion 70 and a neck portion 75. Body portion 70 constitutes the principal mass of the wave concentrator 20 and receives ultrasonic energy provided by the wave generator 15. A threaded fastener 80 extends through aperture 35 of generator 15 and engages a further aperture 85 in body portion 70 to secure generator 15 and concentrator 20 with one another.

Neck portion 75 extends from an end of body portion 70 that is opposite the ultrasonic wave generator 15. In the illustrated embodiment, neck portion 75 is in the form of an elongated tube in which wash cavity 25 is centrally disposed. An opening 90 is located at the end of neck portion 75 that is distal to wave generator 15 to allow entry and removal of the probe 30 to and from the wash cavity 25.

The cross-sectional area through neck portion 75 is substantially smaller than the cross-sectional area through body portion 70. Given this difference in cross-sectional areas, the ultrasonic energy density level experienced in the neck portion 75 is greater than the ultrasonic energy density level experienced in the body portion 70. As such, the ultrasonic energy received from the wave generator 15 is focused into the neck portion 75, including the wash cavity 25 and its contents. In one embodiment, the cross-sectional area through body portion 70 is between 387 and 394 millimeters while the cross-sectional area through neck portion 75 is between 25 and 27.5 millimeters. The ratio between the cross-sectional area of the body portion 70 and the cross-sectional area of neck portion 75 is preferably about 15 to 1, although other ratios may be appropriate in various design contexts.

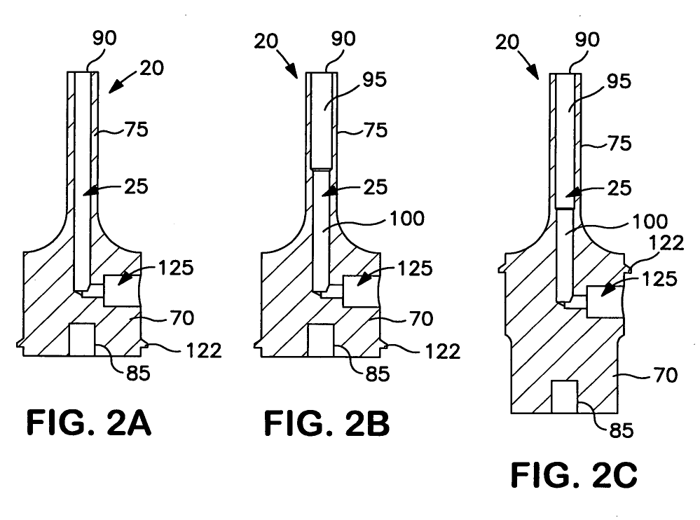

Several different embodiments of an ultrasonic wave concentrator 20 are illustrated in FIGS. 2A through 2C. In the embodiment shown in FIG. 2A, wash cavity 25 has a substantially cylindrical shape with a constant internal diameter throughout its entire length. As such, the cleaning liquid within wash cavity 25 is primarily moved against the probe 30 inside the wash cavity 25 using a shearing action. In the embodiments shown in FIGS. 1, 2B and 2C, the wash cavity 25 is divided into two or more chambers having different diameters. Here, two chambers 95 and 100 are employed where the diameter of chamber 95 is greater than the diameter of chamber 100. By dividing wash cavity 25 into two chambers having different diameters, the cleaning liquid within wash cavity 25 moves against the probe 30 with both shear action and perpendicular action. The difference between the diameters of chambers 95 and 100 is preferably 0.6 millimeters, although other diameter differences may be appropriate in various design contexts.

Ultrasonic wave generator 15 and ultrasonic wave concentrator 20 are resiliently supported within a housing 105 that substantially surrounds the structures. Preferably, the components of housing 105 are formed from an acrylic material or other strong plastic or non-conductive material. In the particular embodiment shown, housing 105 includes a main housing member 110 and an end cap 115. Main housing member 110 and end cap 115 form an annular groove 121 when joined together. A flange 122 extends about an exterior of body portion 70 and engages annular groove 121. O-rings 123 are disposed on each side of flange 122 to resiliently support the generator 15 and concentrator 20 within the housing 105. Preferably, flange 122 is positioned to support the ultrasonic wave generator 15 and ultrasonic wave concentrator 20 within housing 105 at or near a nodal point of the axial motion below the neck portion 75. As such, the motion between housing 105 and the combined generator/wave concentrator structure at the mounting position is minimized.

Apparatus 10 may include a fluid port 125 that extends through sidewalls of housing 105 and body portion 70. Fluid port 125 terminates at a bottom portion of wash cavity 25 and may be used to provide cleaning liquid to wash cavity 25 and/or extract cleaning fluid from wash cavity 25 during various portions of the cleaning process. Other methods for providing and/or removing a cleaning liquid to or from wash cavity 25 may also be employed. For example, in instances in which probe 30 is hollow, the cleaning liquid can be pumped into wash cavity 25 through the hollow of the probe 30.

Any cleaning liquid may be used in the disclosed apparatus. Typically, deionized water or other aqueous solutions of substances known to promote cleaning using ultrasonic energy may be employed. Non-aqueous solutions may also be utilized. The specific temperature, pH, and other characteristics of the cleaning solution are dependent on the particular nature of the probe as well as the substance being cleaned therefrom.

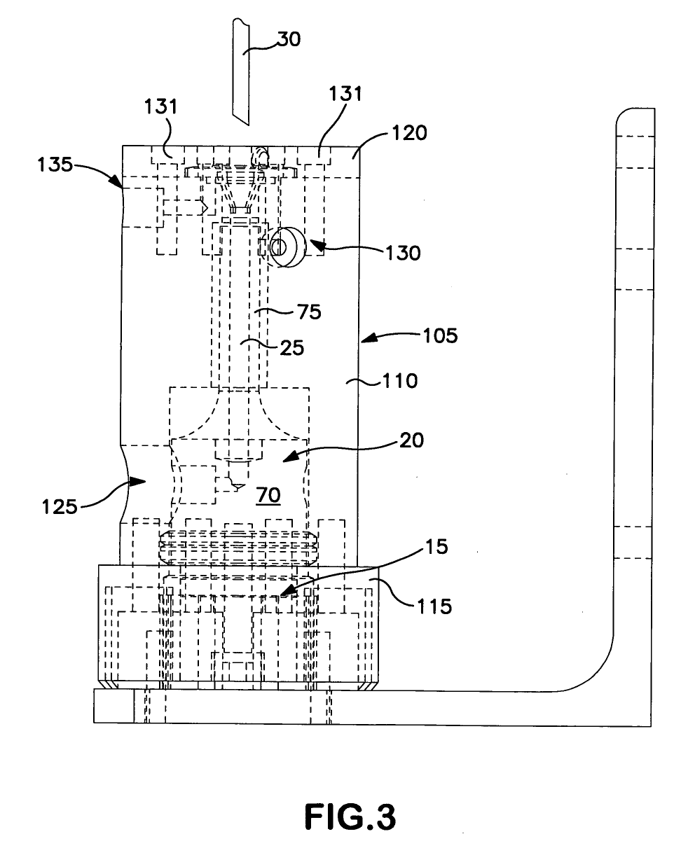

FIG. 3 illustrates an embodiment of a probe cleaning apparatus 10 that includes further fluid flow paths that are provided to enhance the overall cleaning process. The various structures of this embodiment are shown in phantom outline and only the general features of this embodiment have been labeled with numbers for simplification. In this embodiment, apparatus 10 is provided with a first fluid flow path, shown generally at 130, which is adapted to provide a shower of cleaning fluid about the probe 30 and/or into the wash cavity 25. A second fluid flow path, shown generally at 135, is provided to remove cleaning solution from probe 30 and/or wash cavity 25. Each fluid flow path 130 and 135 is disposed proximate to opening 90 of wash cavity 25. A top cap 120 is also employed in this embodiment and is secured to main housing 110 with fasteners 131.

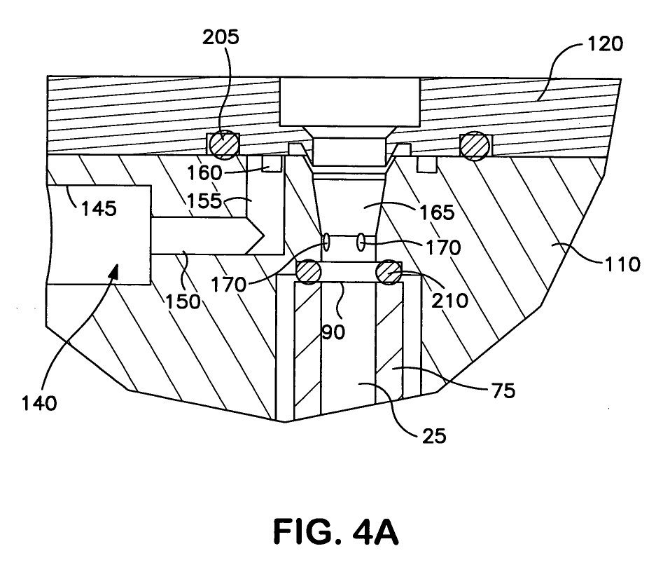

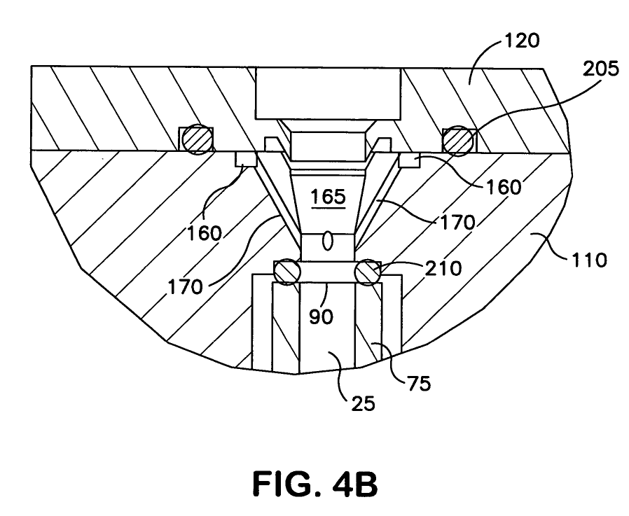

A specific embodiment of the first fluid flow path 130 is shown in FIGS. 4A and 4B. The first fluid flow path 130 includes an inlet 140 having a coupling portion 145 that is adapted to connect flow path 130 to an external cleaning fluid supply line (not shown), a horizontal portion 150 and a vertical portion 155. Inlet 140 provides fluid communication between an external source of cleaning fluid and a cleaning fluid manifold 160. Manifold 160 is constructed in the form of an annulus that proceeds about an auxiliary chamber 165. Auxiliary chamber 165 is disposed above opening 90 of the wash cavity 25 and includes sidewalls that are sloped to direct any fluid within chamber 165 downward into wash cavity 25. Cleaning solution is directed from manifold 160 into auxiliary chamber 165 through a plurality of cleaning nozzles 170. Nozzles 170 are arranged to spray cleaning fluid about the entire periphery of chamber 165 to ensure full external coverage of the probe 30.

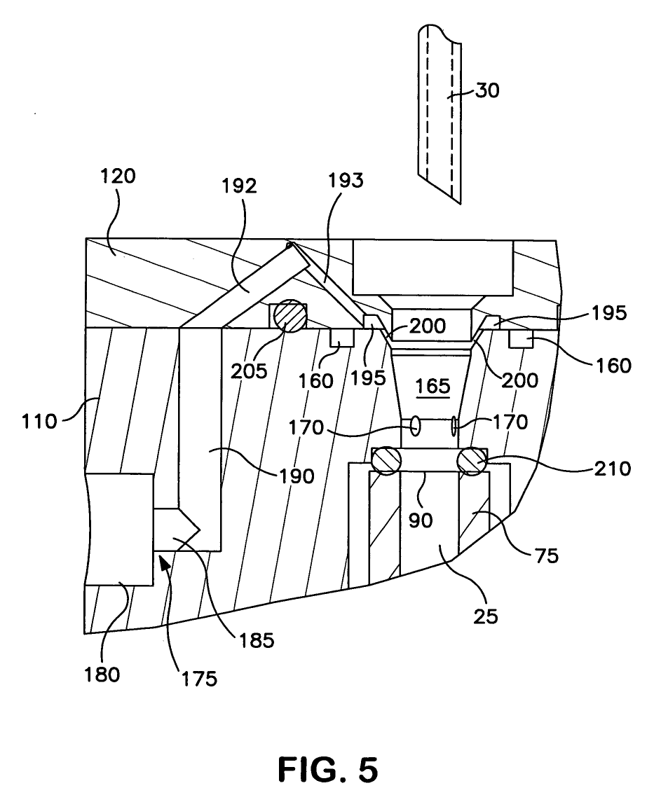

A specific embodiment of the second fluid flow path 135 is shown in FIG. 5. The second fluid flow path 135 includes an inlet 175 having a coupling portion 180 that is adapted to connect flow path 135 to an external pneumatic line (not shown), a horizontal portion 185, a vertical portion 190, an upwardly angled portion 192 and a downwardly angled portion 193. Inlet 175 provides fluid communication between an external pump and a vacuum manifold 195. Vacuum ports 200 extend between vacuum manifold 195 and an upper periphery of auxiliary chamber 165. Ports 200 are arranged to facilitate vacuuming of fluid from the periphery of probe 30. O-rings 205 and 210 are disposed about portions of the first and second fluid flow paths 130 and 135 to selectively seal the paths from other portions of the apparatus 10.

A substantial number of different cleaning processes can be implemented with apparatus 10. In accordance with an exemplary processing sequence, the wash cavity 25 is first filled with a cleaning solution through fluid port 125. An alternating voltage is provided by power supply 65 to the piezoelectric crystals 45 and 50 through electrodes 55 and 60. Typical frequencies for the voltage provided by supply 65 range between 20 kHz and 60 kHz. The applied voltage results in an oscillating expansion and contraction of the piezoelectric crystals 45 and 50 in the direction of arrows 220 of FIG. 1 thereby generating ultrasonic wave energy at the desired energy density level.

The ultrasonic wave energy generated by crystals 45 and 50 of generator and 15 is ultimately received at a first end of the ultrasonic wave concentrator 20. The ultrasonic wave concentrator 20 focuses the ultrasonic energy that it receives into the cleaning fluid contained in the wash cavity 25. Probe 30 may then be lowered into the wash cavity 25 and, optionally, a further amount of cleaning fluid may be dispensed through the probe. Displaced fluid may be contained in wash cavity 25 or allowed to overflow into auxiliary chamber 165 for removal through the vacuum action associated with the second fluid flow path 135. The flow of fluid into wash cavity 25 may be continuous throughout the cleaning process or may be applied intermittently during selected portions of process.

The probe 30 is cleaned through the high-speed movement of the cleaning fluid on the exterior thereof. If there is any cleaning fluid disposed in the probe 30, an amount of the ultrasonic energy is also imparted through the exterior of fluid to probe 30 to provide a degree of interior scrubbing. Optionally, the interior of the probe 30 may be flushed with cleaning fluid to remove any loosened contamination.

After a period of ultrasonic cleaning has elapsed, the cleaning fluid is drained from wash cavity 25 through, for example, fluid port 125. The exterior of the probe 30 may be flushed with a shower spray of cleaning fluid provided through the first fluid flow path 130. This flushing operation may be executed as the probe 30 is extracted from wash cavity 25. Still further, cleaning fluid can be removed from the exterior of probe 30 through of the vacuum provided by the second fluid flow path 135. Optionally, the flushing and vacuuming operations can occur concurrently as the probe is extracted from cavity 25.

Apparatus 10 is particularly suitable for cleaning any small diameters/cross-sectional member. Such items include, but are not limited to, sample probes, needles, wires, pen tips, etc.

Numerous modifications may be made to the foregoing system without departing from the basic teachings thereof. Although the present invention has been described in substantial detail with reference to one or more specific embodiments, those of skill in the art will recognize that changes may be made thereto without departing from the scope and spirit of the invention as set forth in the appended claims.

What is claimed is:

1. An apparatus for ultrasonically cleaning a probe or the like, said apparatus comprising:
an ultrasonic wave generator adapted to generate ultrasonic wave energy at a first energy density level;
an ultrasonic wave concentrator having a wash cavity dimensioned to conform to an exterior portion of said probe, said ultrasonic wave concentrator adapted to concentrate said ultrasonic wave energy received from said ultrasonic wave generator to a second energy density level for provision to said wash cavity, said second energy density level having a greater magnitude than said first energy density level.

2. An apparatus as claimed in claim 1 wherein said ultrasonic wave generator comprises:
a head mass;
a first piezoelectric crystal having first and second opposed surfaces;
a second piezoelectric crystal having first and second opposed surfaces;
a first electrical contact having a first surface proximate to said head mass and a second surface in electrical contact with said first surface of said first piezoelectric crystal;
a second electrical contact having a first surface in electrical contact with said second surface of said first piezoelectric crystal and a second surface in contact with said first surface of said second piezoelectric crystal;
said second surface of said second piezoelectric crystal being disposed proximate to a first end of said ultrasonic wave concentrator.

3. An apparatus as claimed in claim 1 wherein said ultrasonic wave concentrator comprises:
a principal body mass proximate to a first end of said ultrasonic wave concentrator;
a neck portion substantially surrounding said wash cavity, said neck portion extending from said principal body mass and having a reduced cross-section compared to said principal body mass.

4. An apparatus as claimed in claim 1 wherein said ultrasonic wave concentrator comprises a port providing fluid communication with said wash cavity.

5. An apparatus as claimed in claim 1 wherein said wash cavity comprises at least two chambers having different cross-sectional areas.

6. An apparatus as claimed in claim 1 wherein said wash cavity closely conforms to said exterior portion of said probe so as to generate cavitation within said wash cavity.

7. An apparatus as claimed in claim 1 and further comprising a housing substantially surrounding said ultrasonic wave generator and said ultrasonic wave concentrator, said ultrasonic wave generator and said ultrasonic wave concentrator being resiliently mounted within said housing at a vibrational node.

8. An apparatus as claimed in claim 7 wherein said housing comprises one or more flow channels in fluid communication with a region of said wash cavity distal to said ultrasonic wave generator.

9. An apparatus for ultrasonically washing a probe or the like, the apparatus comprising:
an ultrasonic wave generator;
an ultrasonic wave concentrator having a body portion, said body portion having a wash cavity shaped to generally conform to an exterior portion of said probe, a first end adapted to receive ultrasonic energy produced by said ultrasonic wave generator and a second end having an aperture open to said wash cavity and adapted to receive said probe.

10. An apparatus as claimed in claim 9 wherein said ultrasonic wave generator comprises:
a head mass;
a first piezoelectric crystal having first and second opposed surfaces;
a second piezoelectric crystal having first and second opposed surfaces;
a first electrical contact having a first surface proximate to said head mass and a second surface in electrical contact with said first surface of said first piezoelectric crystal;
a second electrical contact having a first surface in electrical contact with said second surface of said first piezoelectric crystal and a second surface in contact with said first surface of said second piezoelectric crystal;
said second surface of said second piezoelectric crystal being disposed proximate to said first end of said ultrasonic wave concentrator.

11. An apparatus as claimed in claim 9 wherein said body portion of said ultrasonic wave concentrator comprises:
a principal body mass proximate to said first end of said ultrasonic wave concentrator;
a neck portion substantially surrounding said wash cavity, said neck portion extending from said principal body mass and having a reduced cross-section compared to said principal body mass.

12. An apparatus as claimed in claim 9 wherein said wash cavity comprises at least two chambers having different cross-sectional areas.

13. An apparatus as claimed in claim 9 wherein said wash cavity closely conforms to said exterior portion of said probe so as to generate cavitation of a cleaning fluid in said wash cavity.

14. An apparatus as claimed in claim 9 and further comprising a housing substantially surrounding said ultrasonic wave generator and said ultrasonic wave concentrator, said ultrasonic wave generator and said ultrasonic wave concentrator being resiliently mounted within said housing at a vibrational node.

15. An apparatus as claimed in claim 14 wherein said housing comprises one or more flow channels in fluid communication with a region of said wash cavity proximate to said aperture at said second end of said ultrasonic wave concentrator.

16. An apparatus for ultrasonically washing a probe or the like, the apparatus comprising:
an ultrasonic wave generator;
an ultrasonic wave concentrator having a wash cavity shaped to closely conform to an exterior portion of said probe, said ultrasonic wave concentrator adapted to focus broad beam ultrasonic wave energy received from said ultrasonic wave generator to a narrower beam of ultrasonic wave energy directed toward a fluid within said wash cavity.

17. An apparatus as claimed in claim 16 wherein said ultrasonic wave generator comprises:
a head mass;
a first piezoelectric crystal having first and second opposed surfaces;
a second piezoelectric crystal having first and second opposed surfaces;
a first electrical contact having a first surface proximate to said head mass and a second surface in electrical contact with said first surface of said first piezoelectric crystal;
a second electrical contact having a first surface in electrical contact with said second surface of said first piezoelectric crystal and a second surface in contact with said first surface of said second piezoelectric crystal;
said second surface of said second piezoelectric crystal being disposed proximate to said first end of said ultrasonic wave concentrator.

18. An apparatus as claimed in claim 16 wherein said ultrasonic wave concentrator comprises:
a principal body mass disposed proximate to said ultrasonic wave generator;
a neck portion substantially surrounding said wash cavity, said neck portion extending from said principal body mass and having a reduced cross-section compared to said principal body mass.

19. An apparatus as claimed in claim 16 wherein said wash cavity comprises at least two chambers having different cross-sectional areas.

20. An apparatus as claimed in claim 16 wherein said wash cavity conforms to said exterior portion of said probe so as to generate cavitation of a cleaning solution in said wash cavity.

21. An apparatus as claimed in claim 16 and further comprising a housing substantially surrounding said ultrasonic wave generator and said ultrasonic wave concentrator, said ultrasonic wave generator and said ultrasonic wave concentrator being resiliently mounted within said housing at a vibrational node.

22. An apparatus as claimed in claim 21 wherein said housing comprises one or more flow channels in fluid communication with a region of said wash cavity that is distal to said ultrasonic wave generator.

23. An apparatus for ultrasonically cleaning a probe or the like, said apparatus comprising:
an ultrasonic wave generator;
a generally horn-shaped ultrasonic wave concentrator having a principal body mass proximate to said ultrasonic wave generator and a neck portion extending from said principal body mass, said principal body mass being adapted to receive ultrasonic energy from said ultrasonic wave generator and to conduct said ultrasonic energy to said neck portion, said neck portion having a reduced cross-section compared to said principal body mass, said neck portion having a centrally disposed wash cavity dimensioned to conform to an exterior portion of said probe and an aperture through which said probe may access said wash cavity.

24. An apparatus as claimed in claim 23 wherein said ultrasonic wave generator comprises:
a head mass;
a first piezoelectric crystal having first and second opposed surfaces;
a second piezoelectric crystal having first and second opposed surfaces;
a first electrical contact having a first surface proximate to said head mass and a second surface in electrical contact with said first surface of said first piezoelectric crystal;
a second electrical contact having a first surface in electrical contact with said second surface of said first piezoelectric crystal and a second surface in contact with said first surface of said second piezoelectric crystal;
said second surface of said second piezoelectric crystal being disposed proximate to said first end of said ultrasonic wave concentrator.

25. An apparatus as claimed in claim 23 wherein said wash cavity comprises at least two chambers having different cross-sectional areas.

26. An apparatus as claimed in claim 23 wherein said wash cavity closely conforms to said exterior portion of said probe so as to generate cavitation of a cleaning fluid in said wash cavity.

27. An apparatus as claimed in claim 23 and further comprising a housing substantially surrounding said ultrasonic wave generator and said ultrasonic wave concentrator, said ultrasonic wave generator and said ultrasonic wave concentrator being resiliently mounted within said housing at a vibrational node.

28. An apparatus as claimed in claim 27 wherein said housing comprises one or more flow channels in fluid communication with a region of said wash cavity proximate to said aperture at said second end of said ultrasonic wave concentrator.

29. A method for ultrasonically washing a probe or the like, the method comprising:
generating ultrasonic wave energy at a first energy density level;
concentrating said ultrasonic wave energy to a second energy density level for provision to a wash cavity, said wash cavity being adapted to closely conform to an exterior portion of said probe, said second energy density level having a greater magnitude than said first energy density level;
directing an amount of fluid into said wash cavity;
directing said probe into said wash cavity.

30. A method as claimed in claim 29 wherein said amount of fluid is directed into said wash cavity through said probe.

31. A method as claimed in claim 29 wherein said amount of fluid is directed into said wash cavity through at least one aperture proximate to a first end of said wash cavity.

32. A method as claimed in claim 29 wherein said amount of fluid is directed into said wash cavity through a plurality of apertures disposed about a periphery of an end of said wash cavity.

33. A method as claimed in claim 31 and further comprising the step of directing a further amount of fluid into said wash cavity through a plurality of apertures disposed about a periphery of a second end of said wash cavity.
